(19) United States
(12) Patent Application Publication
(10) Pub. No.: US 2024/0115890 A1
(43) Pub. Date: Apr. 11, 2024

(54) Biodegradable Nose Filter

(71) Applicants: Maria Isabel Morales-Quezada, San Juan, PR (US); Samira Bilal Fahmi Abdullah, San Juan, PR (US)

(72) Inventors: Maria Isabel Morales-Quezada, San Juan, PR (US); Samira Bilal Fahmi Abdullah, San Juan, PR (US)

(21) Appl. No.: 18/139,856

(22) Filed: Apr. 26, 2023

Related U.S. Application Data
(60) Provisional application No. 63/363,579, filed on Apr. 26, 2022.

(51) Int. Cl. A62B 23/06; B01D 71/16

(52) U.S. Cl. CPC A62B 23/06; B01D 71/16

(57) ABSTRACT

Generally, the present invention provides a nose filter composed by biodegradable materials. The nose filter is adapted to be inserted into the nostrils and includes a flexible housing in form of oval made of CFLEX, that contains the filter with the cellulose acetate membrane, and an arrow made of CFLEX which anatomically engage the nostrils of the user such that one unit extends into each of the user's nostrils.

### RELATED APPLICATIONS

This application claims priority from U.S. Application 63/363,579, filed on Apr. 26, 2022, which the contents of which are fully incorporated by reference.

### BACKGROUND OF THE INVENTION

Air pollution is a major concern around the world. It has been linked to several respiratory disorders and can cause significant health problems. Individuals suffering from allergies, asthma, or other respiratory disorders are particularly vulnerable to the effects of air pollution. Many of these individuals use nose filters to protect themselves from allergens and pollutants. However, most of these filters are made of non-biodegradable materials, which contribute to environmental pollution.

Prior attempts to provide a disposable respiratory nose filter generally fall within one of two categories: mask-style nose filters, i.e., those which are designed to cover the exterior of the nostrils of the nose; and, intrusive-style nose filters, i.e., those which are designed to be inserted into a nasal passageway of the nose.

U.S. Pat. Nos. 3,774,601 and 4,984,302 disclose the use of cotton, wool, polyethylene or polyester as a material used to filter particulate in a nose filter attached to the exterior of the nose. Both filters, however, cover a large portion of the facial area and can irritate the skin it comes is contact with. Generally speaking, mask-like nose filters are extremely awkward, cumbersome and unsightly. Further, when mask-like nose filters become wet, they cling or stick to the face of the wearer making it difficult to speak or breathe. Additionally, such nose filters lack aesthetic appeal.

Intrusive-style nose filters are disclosed in U.S. Pat. Nos. 3,457,917, 3,905,335, 4,052,983, 5,417,205 and 5,568,808. U.S. Pat. No. 3,457,917 discloses a non-disposable nose filter which includes a filter retaining means (i.e., a housing), filtering material, and a detachable cap having a finger gripping means provided at the end of the cap. Unlike the present invention, the filter retaining means in U.S. Pat. No. 3,457,917 is formed from a hard molded plastic such as polytetrafluorethylene or Bakelite.

### FIELD OF THE INVENTION

This invention relates to a nose filter and more particularly concerns a nose filter made of biodegradable materials.

### BRIEF DESCRIPTION OF DRAWINGS

FIG. 1—Prototype of the biodegradable nose filter.

FIG. 2—CFLEF arrow that unite the two membranes made of CFLEX material.

FIG. 3—Border made of CFLEX.

FIG. 4—Membrane that contains filter of Cellulose acetate.

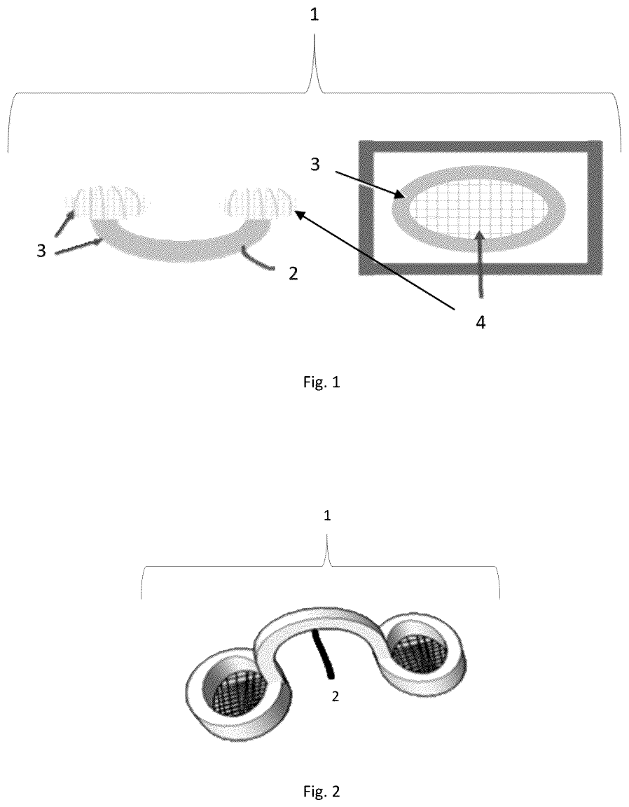

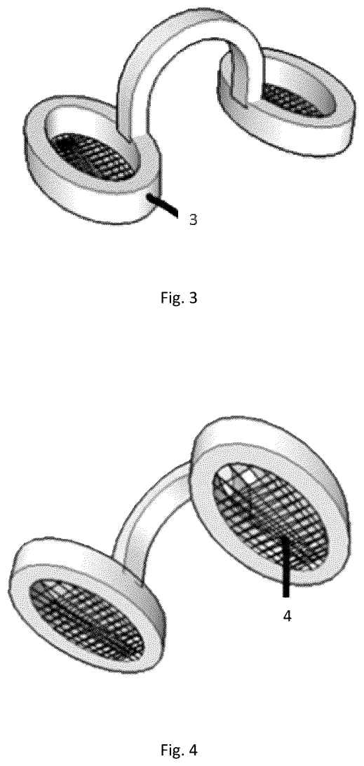

### DETAILED DESCRIPTION OF THE INVENTION

The present invention is a nose filter made of biodegradable materials. A biodegradable nose filter is a device that is designed to be worn in the nostrils to filter out airborne pollutants and allergens. Unlike traditional nose filters, which are typically made of plastic and can take years to decompose, this biodegradable nose filter is made from materials that can break down naturally over time. These filters are designed to be used for a short period of time, usually a few hours, and then disposed of in a compost bin or other organic waste container. This helps to reduce the environmental impact of disposable nose filters, which can be a significant source of plastic waste.

The nose filter includes 1 the outer part made of CFLEX material which unite by an 2 arrow to two membranes in the two inner parts. This inner part at the same time had two materials: 3 the border that makes the membranes stay in place, and 4 the membrane made of cellulose acetate, which prevents the entry of the microplastics.

CFlex is a type of medical-grade thermoplastic elastomer (TPE) material that is commonly used in the manufacturing of medical devices such as catheters, tubing, and other flexible medical components.

CFlex is known for its high flexibility, durability, and resistance to kinking, making it a popular choice for medical applications that require long-term use and frequent flexing. It is also resistant to cracking and tearing and has excellent tensile strength and elongation properties. In addition to its physical properties,

CFlex is also biocompatible, meaning that it is non-toxic and does not cause an adverse reaction when it comes into contact with the human body. This makes it suitable for use in medical applications where the material will be in contact with blood, tissue, or other bodily fluids.

Cellulose acetate is a thermoplastic polymer that is derived from cellulose, which is the main structural component of plants. It is a synthetic material that is made by chemically modifying cellulose, which makes it more durable, flexible, and resistant to water and other chemicals.

In addition to its versatility and durability, cellulose acetate is also biodegradable and compostable, which makes it an eco-friendly alternative to traditional plastics. When disposed of properly, cellulose acetate can break down naturally over time, reducing its impact on the environment.

The membranes are kept and distributed in a hydrated gel solution that have a similar composition to human body mucus. The mucus solution has the following composition by percent: 95% H20, 5% mucin glycoprotein, 80% carbohydrate content, 20% protein core, and electrolytes.

Only a small portion of the nose filter is exposed from the nostril.

The nose filter will have a transparent appearance that resembles the skin colors of the individuals.

### DETAILED DESCRIPTION OF THE PREFERRED EMBODIMENT

The nose filter may be operative for filtering dust, germs, allergic matter, or other foreign particulate from the air passing through the nostrils into the sinus cavity. It has been found that as the air passes through the filter, the air is also warmed before it reaches the sinus cavity and eventually the lungs.

The nose filter can be designed to easily inserted and removed from the nostril, and which will conform to the shape of the nasal passageway without irritating the sensitive inner wall of the nostril.

Those skilled in the art will appreciate that the invention can be embodied in other forms and ways, without losing the scope of the invention. The embodiments described herein should be considered as illustrative and not restrictive.

What is claimed:

1. A biodegradable nose filter comprising of:
two oval shaped filters connected by a CFLEX arrow;
wherein the oval shaped filters contain an outer part made of CFLEX that supports an inner part membrane made of cellulose acetate.

2. The biodegradable nose filter of claim 1, wherein the inner part membrane made of cellulose acetate is soaked with a mucus-like solution.
